(19) United States
(12) Patent Application Publication
(10) Pub. No.: US 2016/0212252 A1
(43) Pub. Date: Jul. 21, 2016

(54) DISPOSABLE ANTIMICROBIAL CELL PHONE CASING

(71) Applicant: Elizabeth Parker, Mebane, NC (US)

(72) Inventor: Elizabeth Parker, Mebane, NC (US)

(21) Appl. No.: 14/599,808

(22) Filed: Jan. 19, 2015

(51) Int. Cl. H04M 1/11; H04B 1/3888

(52) U.S. Cl. CPC H04M 1/11; H04B 1/3888

(57) ABSTRACT

An antimicrobial cell phone casing for preventing the accumulation of microbes on and the spread of microbes from the surface of a mobile device. The adjustable antimicrobial cell phone casing defines a rectangular plastic bag style housing having an exterior surface covered with the conventional antimicrobial film coating, either a reclosable top opening or a reclosable side opening, a set of top sound holes, and a set of bottom holes. Both the reclosable top opening and a reclosable side opening define press-to-seal zipper strips. The top sound holes define a set of holes disposed in each top corner of the plastic housing, while the bottom holes define a set of holes disposed in the middle of the bottom of the plastic housing.

### BACKGROUND OF THE INVENTION

1. Field of the Invention

This invention relates generally to mobile device housings and, more particularly, to a disposable cell phone case having integral antimicrobial properties.

2. Description of the Prior Art

The use of mobile computer devices, such as smartphones (or other modern cell phones) and tablets is well known. In modern societies, such mobile devices have become omnipresent, with users commonly taking them almost everywhere and using them constantly. A problem which still exists, however, is that mobile devices are prone to carrying and accumulating bacteria, viruses, and other harmful microbes on their surfaces. Through just ordinary use, including typing, dialing, web browsing, users easily transfer such microbial life onto their hands and faces, thereby becoming vulnerable to disease, infection and even allergy flare ups. Because of how routinely mobile devices are used, no amount of hand washing would seem to be sufficient to solving this problem. Thus, there remains a need for an antimicrobial cell phone casing which would allow a user to selectively place their mobile device inside a transparent enclosure that does not impair the ability to use the device. It would be helpful if such an antimicrobial cell phone casing was removable and replaceable so as to allow the periodic use of fresh covers. It would be additionally desirable for such an antimicrobial cell phone casing to be constructed in either a side loading design and a top loading design so it is suitable for various mobile device designs.

The Applicant's invention described herein provides for an antimicrobial cell phone casing adapted to allow a user encase their mobile device in a microbe free structure and still use it. The primary aspects in Applicant's antimicrobial cell phone casing are an elastic case body having a primary opening and sound holes. When in operation, the antimicrobial cell phone casing enables a user to operate their mobile device without transferring microbes onto their hands or face. As a result, many of the limitations imposed by prior art structures are removed.

### SUMMARY OF THE INVENTION

An adjustable antimicrobial cell phone casing for preventing the accumulation of microbes on and the spread of microbes from the surface of a mobile device. The adjustable antimicrobial cell phone casing defines a rectangular plastic bag style housing having an exterior surface covered with the conventional antimicrobial film coating, either a reclosable top opening or a reclosable side opening, a set of top sound holes, and a set of bottom holes. Both the reclosable top opening and a reclosable side opening define press-to-seal zipper strips. The top sound holes define a set of holes disposed in each top corner of the plastic housing, while the bottom holes define a set of holes disposed in the middle of the bottom of the plastic housing.

It is an object of this invention to provide an antimicrobial cell phone casing which would allow a user to selectively place their mobile device inside a transparent enclosure that does not impair the ability to use the device.

It is another object of this invention to provide an antimicrobial cell phone casing that was removable and replaceable so as to allow the periodic use of fresh covers.

It is yet another object of this invention to provide an antimicrobial cell phone casing constructed in either a side loading design and a top loading design so it is suitable for various mobile device designs.

These and other objects will be apparent to one of skill in the art.

### BRIEF DESCRIPTION OF THE DRAWINGS

FIG. 1 is a front elevational view of an antimicrobial cell phone casing built in accordance with a top loading embodiment of the present invention having a cell phone disposed inside.

FIG. 2 is a back elevational view of an antimicrobial cell phone casing built in accordance with a side loading embodiment of the present invention having a cell phone disposed inside.

### DETAILED DESCRIPTION OF THE INVENTION

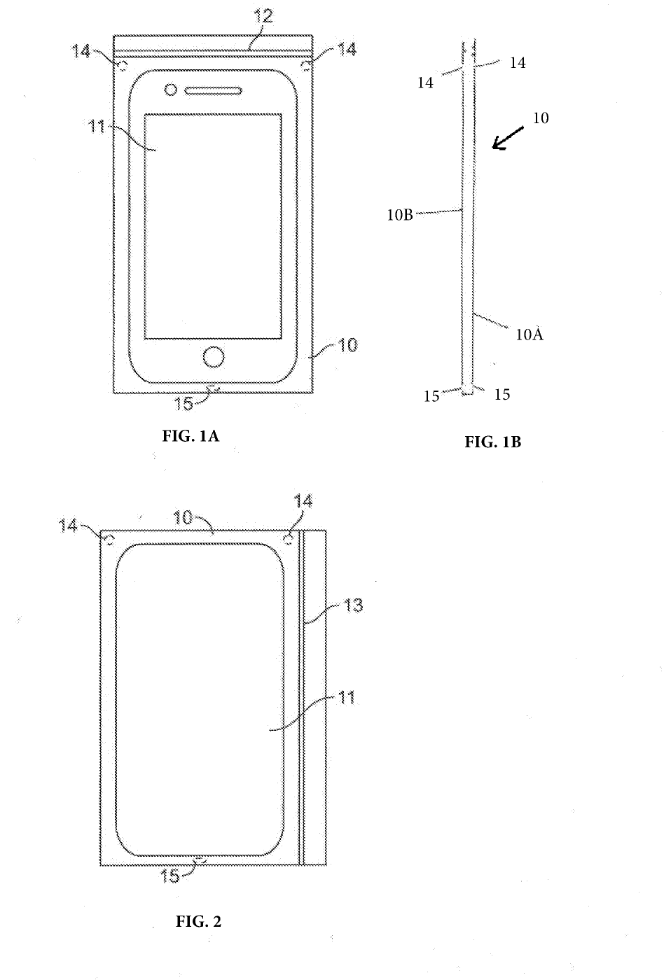

Referring now to the drawings and in particular FIGS. 1 and 2, an adjustable antimicrobial cell phone casing 10 is shown having a mobile device 11 disposed therein. It is contemplated that the antimicrobial cell phone casing 10 may be sized to fit various sized mobile devices 11 provided they are substantially flat. Accordingly, smaller size antimicrobial cell phone casings 10 are available for cell phones and larger size antimicrobial cell phone casing 10 are available for tablets.

The antimicrobial cell phone casing 10 is defines a rectangular plastic bag style housing having either a reclosable top opening 12 or a reclosable side opening 13, a set of top sound holes 14, and a set of bottom holes 15. The plastic material of the plastic bag style housing defines an elastic material that is sufficient thin to not interfere with the operation of a touchscreen on the mobile device 11. Both the reclosable top opening 12 and a reclosable side opening 13 define press-to-seal zipper strips, and are distinguished based on their location relative to the plastic housing.

In the preferred embodiment, the top sound holes 14 define a set of holes disposed in each top corner of the plastic housing, while the bottom holes 15 define a set of holes disposed in the middle of the bottom of the plastic housing. It is contemplated that the set of top sound holes 14 and a set of bottom holes 15 each are disposed in corresponding locations on both the front and back sides of the plastic housing, thereby enabling sound waves to easily enter and exit the antimicrobial cell phone casing 10 when the mobile device 11 is in use.

In the preferred embodiment, the exterior surface of the antimicrobial cell phone casing 10, the surface which is handled by a user, is covered with the conventional antimicrobial film coating. In some embodiments, the interior surface of the antimicrobial cell phone casing 10, the surface which contacts the mobile device 11, is also covered with a conventional antimicrobial film coating.

The instant invention has been shown and described herein in what is considered to be the most practical and preferred embodiment. It is recognized, however, that departures may be made therefrom within the scope of the invention and that obvious modifications will occur to a person skilled in the art.

1. An antimicrobial cell phone casing for receiving and holding a mobile device, comprising:
a housing having a front side, a back side, exterior surface, interior surface, and at least one of a reclosable top opening and a reclosable side opening;
the at least one of said reclosable top opening and said reclosable side opening each adapted to enable a mobile device to be held to be removably placed inside the housing; and
said housing adapted to enable a user to actuate a user interface of a mobile device disposed therein through exerting pressure on the user interface through the housing.

2. The antimicrobial cell phone casing of claim 1, wherein said housing includes at least one sound hole disposed therein.

3. The antimicrobial cell phone casing of claim 2, wherein said housing includes at least one top sound hole and at least one bottom sound hole.

4. The antimicrobial cell phone casing of claim 3, wherein said housing includes at least one top sound hole in a corresponding location on its front side and back side and at least one bottom sound hole in a corresponding location on its front surface and back surface.

5. The antimicrobial cell phone casing of claim 1, wherein said housing includes a conventional antimicrobial film coating on its exterior surface.

6. The antimicrobial cell phone casing of claim 4, wherein said housing includes a conventional antimicrobial film coating on its exterior surface.

7. An antimicrobial cell phone casing for receiving and holding a mobile device, comprising:
a housing having a front side, a back side, exterior surface, interior surface, and at least one of a reclosable top opening and a reclosable side opening;
the at least one said reclosable top opening and said reclosable side opening each adapted to enable a mobile device to be held to be removably placed inside the housing;
said housing adapted to enable a user to actuate a user interface the operation of a mobile device disposed therein through exerting pressure on the user interface through the housing;
said housing includes at least one top sound hole in a corresponding location on both its front side and back side and at least one bottom sound hole in a corresponding location on both its front surface and back surface; and
said housing includes a conventional antimicrobial film coating on its exterior surface.

8. The antimicrobial cell phone casing of claim 7, wherein said housing includes a conventional antimicrobial film coating on its exterior surface.
